(19) United States
(12) Patent Application Publication
(10) Pub. No.: US 2016/0085339 A1
(43) Pub. Date: Mar. 24, 2016

(54) TOUCH PANEL SUBSTRATE AND ELECTRONIC APPARATUS

(71) Applicant: SHARP KABUSHIKI KAISHA, Osaka (JP)

(72) Inventors: Yuhji YASHIRO, Osaka (JP); Kazuya YOSHIMURA, Osaka (JP); Shinji MATSUMOTO, Osaka (JP)

(73) Assignee: Sharp Kabushiki Kaisha, Osaka (JP)

(21) Appl. No.: 14/891,317

(22) PCT Filed: Feb. 26, 2014
(86) PCT No.: PCT/JP2014/054693

§ 371 Date: Nov. 13, 2015

(30) Foreign Application Priority Data
May 16, 2013 (JP) 2013-104369

(51) Int. Cl. G06F 3/044; G06F 3/041

(52) U.S. Cl. CPC G06F 3/044; G06F 3/0412; G06F 2203/04112

(57) ABSTRACT

A touch panel substrate that has more uniform light transmittance in the surface thereof is provided. An electrode layer is made of a mesh of first conductive lines. The mesh has first cuts that partition the first conductive lines to form a plurality of first sensor electrodes. The plurality of first sensor electrodes each further include second cuts while maintaining an electrical continuity within each of the plurality of first sensor electrodes.

### TECHNICAL FIELD

The present invention relates to a touch panel substrate and an electronic apparatus that uses the touch panel substrate.

### BACKGROUND ART

Transparent electrodes such as ITO (indium tin oxide) are used for sensor electrodes of a touch panel, for example. However, when ITO is used for the sensor electrodes of a large-screen touch panel, the detection sensitivity decreases because the resistance of ITO is large.

To address this problem, there is technology that lowers the resistance of sensor electrodes while maintaining adequate transmittance by using a mesh of conductive lines formed in a mesh-pattern as sensor electrodes.

Patent Document 1 discloses a touch panel apparatus that uses the technology described above. FIG. 20 is a plan view showing a configuration in which a first electrode substrate and a second electrode substrate of the touch panel apparatus are allowed to overlap. The touch panel apparatus according to Patent Document 1 includes a first electrode substrate 410 and a second electrode substrate 420 that overlaps with the first electrode substrate 410.

The first electrode substrate 410 includes a plurality of first electrodes 411 (sensor electrodes) that are made of conductive lines and run parallel to one another. The second electrode substrate 420 includes a plurality of second electrodes 421 (sensor electrodes) that are made of conductive lines and run parallel to one another in the direction perpendicular to the direction in which the first electrodes 411 run. Because the first electrodes 411 and the second electrodes 421 are provided at prescribed intervals, each of the first electrodes 411 is mutually insulated from one another, and each of the second electrodes 421 is mutually insulated from one another.

When the user touches the touch panel apparatus, capacitance changes at the intersections of the first electrodes 411 and the second electrodes 421. In this configuration, by detecting the change in capacitance, the touch panel apparatus computes the position where a finger of the user touches the touch panel as coordinates on the detection surface of the touch panel.

Patent Document 2 discloses a capacitive touch switch that has two mesh-patterned electrodes that face each other. FIG. 21 is an enlarged view of a part of the mesh-patterned electrodes of the touch switch according to Patent Document 2. As shown in FIG. 21, a mesh-patterned electrode 510 is an electrode made of a plurality of conductive lines formed in mesh-shapes, and is partitioned into a plurality of conductive regions 511 disposed approximately in parallel at prescribed intervals and a plurality of non-conductive regions 514 disposed between each of the conductive regions 511. The non-conductive regions 514 include a plurality of cuts 515 that sever the conductive lines into island-like shapes. By virtue of the cuts 515, the non-conductive regions 514 insulate the adjacent conductive regions 511 from each other.

### RELATED ART DOCUMENTS

### Patent Documents

Patent Document 1: Japanese Patent No. 4989749 (published on Aug. 1, 2012)

Patent Document 2: Japanese Patent Application Laid-Open Publication No. 2010-262529 (Published on Nov. 18, 2010)

### SUMMARY OF THE INVENTION

### Problems to be Solved by the Invention

However, the sensor electrodes of the touch panel apparatus according to Patent Document 1 are disposed at prescribed intervals, and the gap between the adjacent sensor electrodes is an empty region where the conductive lines are not provided. This results in a region with higher transmittance than the region where the conductive lines are provided, making the transmittance in a plan view uneven.

Similarly, because in the touch switch according to Patent Document 2 the conductive regions lack the cuts while the non-conductive regions have the cuts, the transmittance is higher in the non-conductive regions than the conductive regions, making the transmittance in a plan view uneven.

As described above, because the transmittance in a plan view is uneven in both the touch panel apparatus according to Patent Document 1 and the touch switch according to Patent Document 2, the user using a display equipped with a touch switch sees a pattern that corresponds to the transmittance, and the display quality of the displayed image deteriorates.

The present invention was made in view of the problems described above. An aim of the invention is to provide a touch panel substrate with more even transmittance of the display surface and an electronic apparatus that uses this touch panel substrate.

### Means for Solving the Problems

To solve problems described above, a touch panel substrate according to the present invention includes: an electrode layer made from a mesh of conductive lines on the substrate, the mesh having first cuts, the first cuts partitioning the mesh to form a plurality of electrodes each insulated from one another; wherein the conductive lines are provided in a mesh-pattern in the electrode layer, wherein first cuts are provided in the electrode layer, the first cuts disconnecting the conductive lines and partitioning the mesh-patterned conductive lines into the plurality of electrodes each insulated from one another, and wherein the plurality of electrodes each further include second cuts that disconnect the conductive lines that are included within the electrodes that maintain an electrical continuity within the electrode.

### Effects of the Invention

According to one embodiment of the present invention, a touch panel substrate with more even transmittance of the display surface can be provided.

### BRIEF DESCRIPTION OF THE DRAWINGS

FIG. 1 is a cross-sectional view of an electronic apparatus according to Embodiment 1.

FIG. 2 is a plan view showing a configuration of a first electrode layer of a touch panel substrate according to Embodiment 1, FIG. 2(a) is a view showing a configuration of first sensor electrodes, and FIG. 2(b) is a view showing a configuration of first conductive lines.

FIG. 3 is a plan view showing a configuration of a second electrode layer of a touch panel substrate according to Embodiment 1, FIG. 3(a) is a view showing a configuration of second sensor electrodes, and FIG. 3(b) is a view showing a configuration of second conductive lines.

FIG. 4 is a plan view showing cuts in the first conductive lines in the first electrode layer of the touch panel substrate according to Embodiment 1.

FIG. 5 is a plan view showing a detailed configuration of the first conductive lines of the touch panel substrate according to Embodiment 1.

FIG. 6 is a plan view showing cuts in first conductive lines in a first electrode layer of a conventional touch panel substrate as a comparison example.

FIG. 7 is a plan view showing a detailed configuration of the first conductive lines of the conventional touch panel substrate as a comparison example.

FIG. 8 is a plan view used to describe the transmittance of the first electrode layer, FIG. 8(a) is a plan view of the first electrode layer of the touch panel substrate in the comparison example, and FIG. 8(b) is a plan view of the first electrode layer of the touch panel substrate according to the present invention.

FIG. 9 is a Campbell-Robson chart in which the vertical axis represents contrast sensitivity and the horizontal axis represents spatial frequency.

FIG. 10 is a plan view of a portion of the first electrode layer of the touch panel substrate according to Embodiment 1 used to describe the position where cuts are provided, FIG. 10(a) is a plan view of a border between a first sensor electrode and a dummy electrode, and FIG. 10(b) is a plan view showing a first sensor electrode or a dummy electrode.

FIG. 11 is a plan view showing a first electrode layer of a touch panel substrate according to Embodiment 2, FIG. 11(a) is a view showing cuts in first conductive lines of a first electrode layer, and FIG. 11(b) is an enlarged view of a dummy electrode shown in FIG. 11(a).

FIG. 12 is a plan view showing a detailed configuration of the first conductive lines of the touch panel substrate according to Embodiment 2.

FIG. 13 is a plan view showing a configuration of a first electrode layer of a touch panel substrate according to Embodiment 3, FIG. 13(a) is a view showing a configuration of first sensor electrodes, and FIG. 13(b) is a view showing a configuration of first conductive lines.

FIG. 14 is a plan view showing a configuration of a second electrode layer of a touch panel substrate according to Embodiment 3, FIG. 14(a) is a view showing a configuration of second sensor electrodes, and FIG. 14(b) is a view showing a configuration of second conductive lines.

FIG. 15 is a plan view showing cuts in the first conductive lines in the first electrode layer of the touch panel substrate according to Embodiment 3.

FIG. 16 is a plan view showing a detailed configuration of the first conductive lines of the touch panel substrate according to Embodiment 3.

FIG. 17 is a cross-sectional view of an electronic apparatus according to Embodiment 4.

FIG. 18 is a plan view showing a configuration of an electrode layer of a touch panel substrate according to Embodiment 4, FIG. 18(a) is a view showing a configuration of first sensor electrodes and second sensor electrodes, and FIG. 18(b) is a view showing a configuration of first conductive lines and second conductive lines.

FIG. 19 is a plan view showing a configuration of a bridge portion of a touch panel substrate according to Embodiment 4, FIG. 19(a) is a view showing a bridge that connects grid electrodes, FIG. 19 (b) is a plan view showing a bridge-forming layer, and FIG. 19 (c) is a plan view showing a contact-hole-forming layer.

FIG. 20 is a plan view showing a configuration in which a first electrode substrate and a second electrode substrate of a touch panel apparatus according to Patent Document 1 are allowed to overlap.

FIG. 21 is an enlarged view of a part of mesh-patterned electrodes of a touch switch according to Patent Document 2.

### DETAILED DESCRIPTION OF EMBODIMENTS

### Embodiment 1

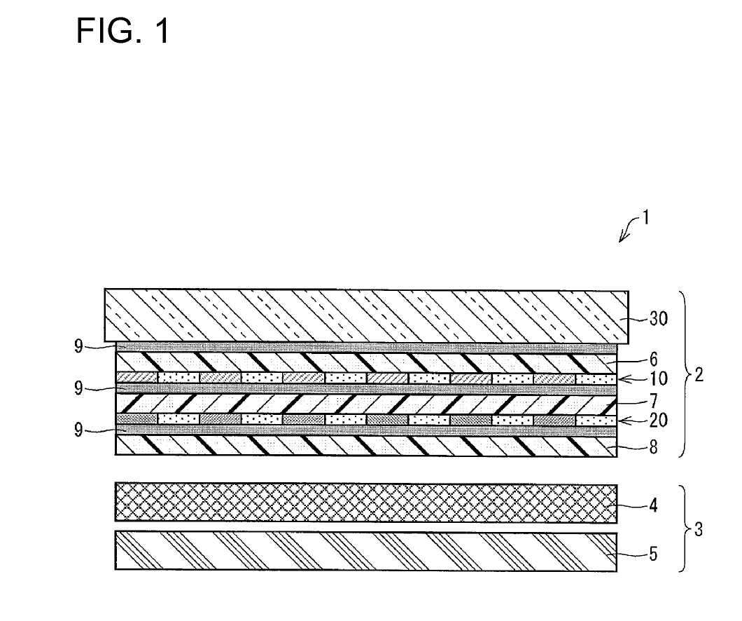

Below, embodiments of the present invention are described in detail using FIGS. 1 to 10.

FIG. 1 is a cross-sectional view of an electronic apparatus 1 according to the present embodiment. As shown in FIG. 1, the electronic apparatus 1 includes a touch panel substrate 2 and a display device 3.

Various display devices such as a liquid crystal display device or an organic EL display device can be used for the display device 3. The display device 3 includes a display panel 4 and a backlight 5 disposed on the back side of the display panel 4 (the surface opposite to the display surface) and emits light toward the display panel 4. In addition, the display device 3 includes various driver circuits (not shown) that control an image displayed on the display surface of the display panel 4.

<Touch Panel Substrate>

The touch panel substrate 2 is a capacitive touch panel substrate disposed on the display surface side of the display panel 4. The touch panel substrate 2 is configured by layering a glass substrate 30, a first electrode substrate 6, a first electrode layer 10 (an electrode layer, an X axis sensor electrode sheet), a second electrode substrate 7, a second electrode layer 20 (an electrode layer, a Y axis sensor electrode sheet), and a substrate 8 in this order. Each of the following three sets of layers—the glass substrate 30 and the first electrode substrate 6, the first electrode layer 10 and the second electrode substrate 7, and the second electrode layer 20 and the substrate 8—is bonded together with an adhesive layer 9 therebetween.

An insulating substrate with high transmittance such as polyethylene terephthalate (PET) can be used for the first electrode substrate 6, the second electrode substrate 7, and the substrate 8. The glass substrate 30 is the surface that an object to be detected touches.

<Electrode Layer>

Below, the configuration of the first electrode layer 10 and the second electrode layer 20 of the touch panel substrate 2 according to the present embodiment is described in detail.

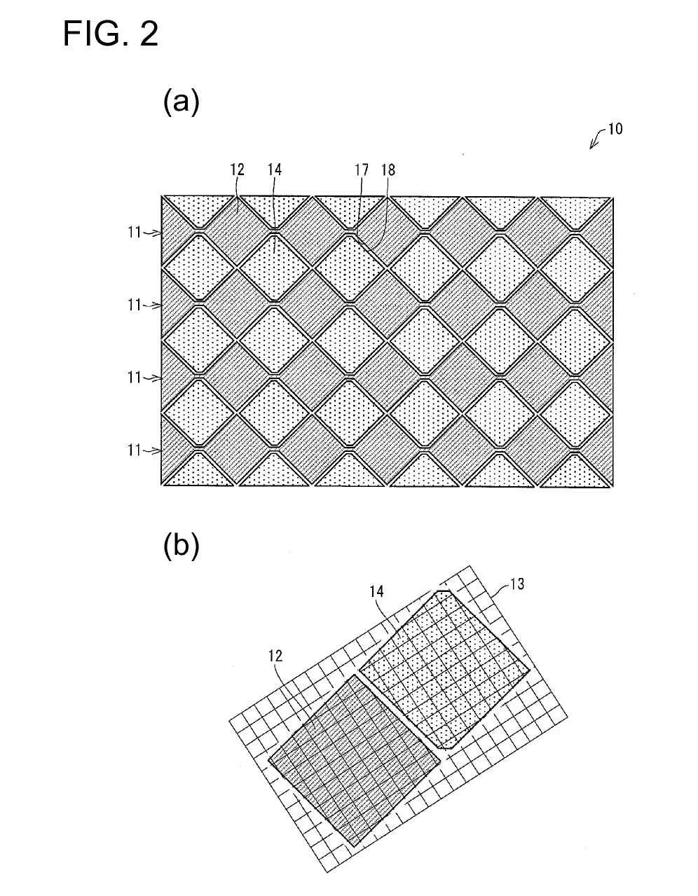

FIG. 2 is a plan view showing a configuration of a first electrode layer of a touch panel substrate according to Embodiment 1, FIG. 2(a) is a view showing a configuration of first sensor electrodes, and FIG. 2(b) is a view showing a configuration of first conductive lines.

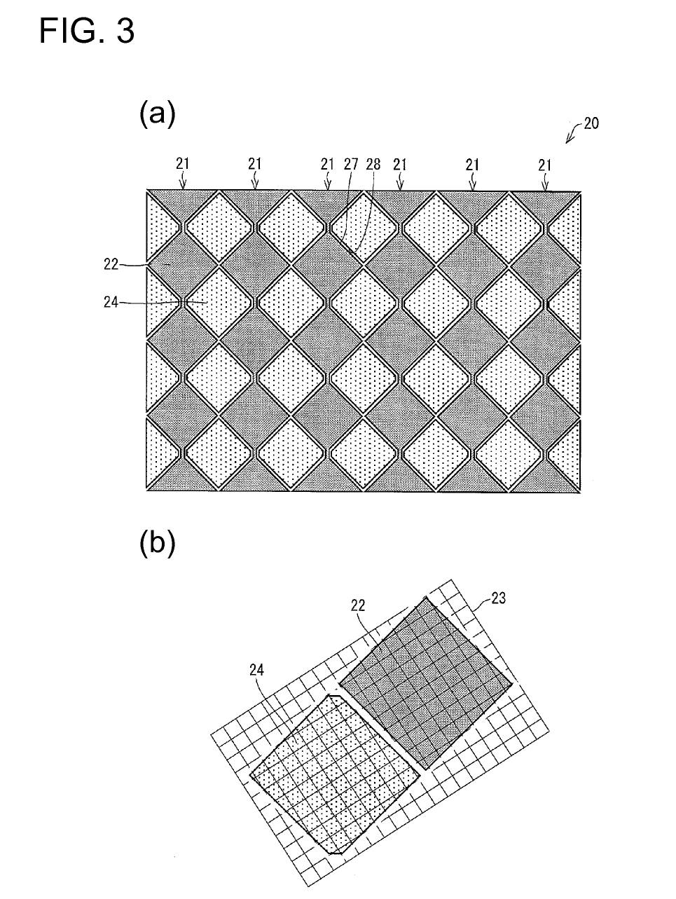

FIG. 3 is a plan view showing a configuration of a second electrode layer of a touch panel substrate according to Embodiment 1, FIG. 3(a) is a view showing a configuration of second sensor electrodes, and FIG. 3(b) is a view showing a configuration of second conductive lines.

As shown in FIG. 2(a), a plurality of first sensor electrodes 11 (sensor electrodes) that extend in the horizontal direction in the figure are disposed in the first electrode layer 10. Each of the first sensor electrodes 11 has a plurality of grid electrodes 12 shaped like a square, and the adjacent grid electrodes 12 are connected to each other at one of the vertices thereof. Between each of the grid electrodes 12, a dummy electrode 14 that is adjacent to the first sensor electrodes 11 is formed.

As shown in FIG. 2(b), the first sensor electrode 11 and the dummy electrode 14 are constituted by first conductive lines 13 (conductive lines) that are disposed in a mesh-pattern. More specifically, the first conductive lines 13 are disposed in a mesh-pattern on the entire surface of the first electrode layer 10 in a uniform manner. Cutting the first conductive lines 13 along the outline of the first sensor electrode 11 isolates the first sensor electrode 11, which forms the first sensor electrode 11 and the dummy electrode 14 on the first electrode layer 10.

In a similar manner, as shown in FIG. 3(a), a plurality of second sensor electrodes 21 (sensor electrodes) that extend in the vertical direction in the figure are disposed in the second electrode layer 20. Each of the second sensor electrodes 21 has a plurality of grid electrodes 22 shaped like a square, and the adjacent grid electrodes 22 are connected to each other at one of the vertices thereof. A dummy electrode 24 that is adjacent to the second sensor electrodes 21 is formed between each of the grid electrodes 22.

As shown in FIG. 3(b), the second sensor electrode 21 and the dummy electrode 24 are constituted by second conductive lines 23 (conductive lines) that are disposed in a mesh-pattern. More specifically, the second conductive lines 23 are disposed in a mesh-pattern on the entire surface of the second electrode layer 20 in a uniform manner. Cutting the second conductive lines 23 along the outline of the second sensor electrode 21 isolates the second sensor electrode 21, which forms the second sensor electrode 21 and the dummy electrode 24 on the second electrode layer 20.

The first electrode layer 10 and the second electrode layer 20 are attached such that the first sensor electrodes 11 and the second sensor electrodes 21 mutually intersect and the grid electrodes 12 and the dummy electrodes 24 as well as the grid electrodes 22 and the dummy electrodes 14 overlap in a plan view.

As described above, the touch panel substrate 2 according to the present embodiment includes the first sensor electrodes 11 and the second sensor electrodes 21 disposed in a diamond pattern. Capacitance is formed between the first sensor electrodes 11 and the second sensor electrodes 21. When an object to be detected such as a finger of a person touches or approaches the surface (the glass substrate 30) of the touch panel substrate 2, the magnitude of the capacitance changes. By detecting the change in capacitance using a position detection circuit (not shown) connected to the first sensor electrodes 11 and the second sensor electrodes 21, the contact point or proximate location of the object to be detected on the surface of the touch panel substrate 2 can be determined.

By applying drive voltage to the first sensor electrodes 11 and measuring the change in voltage in the second sensor electrodes 21, the first sensor electrodes 11 (row) and the second sensor electrodes 21 (column) for which the capacitance has changed are determined, for example. A known circuit can be used for the position detection circuit for detecting the coordinates of the object to be detected.

Below, a more detailed configuration of the first sensor electrode 11 of the touch panel substrate 2 according to the present embodiment is described specifically.

<First Sensor Electrode and Dummy Electrode>

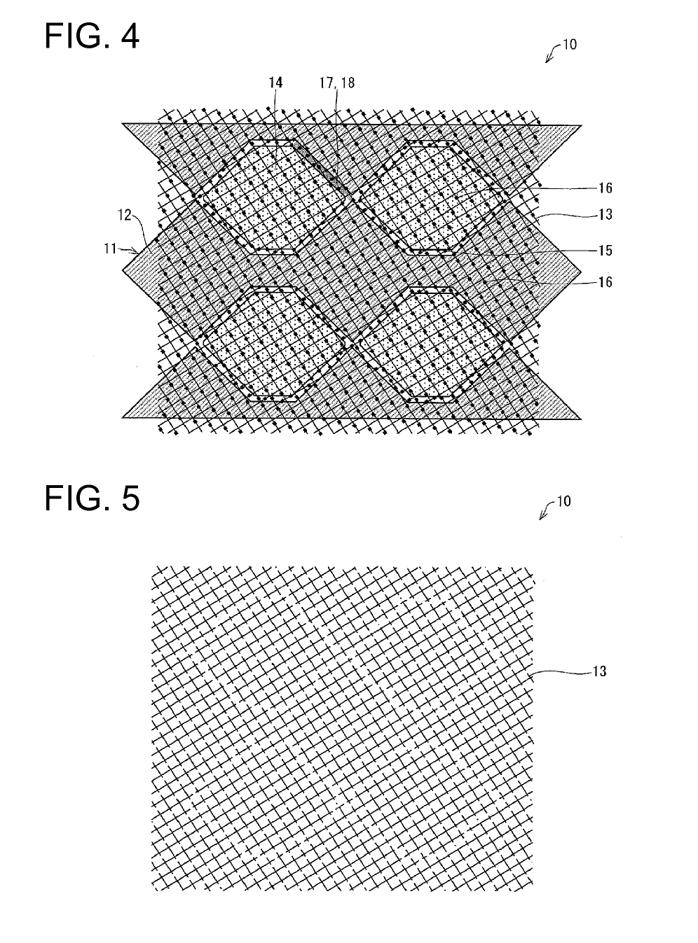

FIG. 4 is a plan view showing cuts in first conductive lines in a first electrode layer of a touch panel substrate according to the present embodiment. FIG. 5 is a plan view showing a detailed configuration of first conductive lines of a touch panel substrate according to the present embodiment.

For ease of description, in FIG. 4, the shapes of the first conductive lines 13, the first sensor electrodes 11, and the dummy electrodes 14 are shown, and the positions where the first conductive lines 13 are cut are shown with square dots. FIG. 5 shows only the first conductive lines 13, which include the cuts.

As shown in FIGS. 4 and 5, the first conductive lines 13 disposed in a mesh-pattern in a uniform manner on the first electrode layer 10 are partitioned by first cuts 15 provided along the outline of the first sensor electrodes 11. The first sensor electrodes 11 and the dummy electrodes 14 are formed corresponding to the partitions made on the first conductive lines 13.

Furthermore, second cuts 16 are provided. The second cuts 16 sever the first conductive lines 13 that constitute the first sensor electrodes 11 while maintaining the electrical continuity of the first sensor electrodes 11. The first conductive lines 13 also include the second cuts 16 (second cuts for dummy electrodes) that sever the first conductive lines 13 that constitute the dummy electrodes 14. This improves the transmittance of the first sensor electrodes 11 and the dummy electrodes 14. Below, a reference only to “cuts” is meant to include both the first cuts 15 and the second cuts 16.

The second cuts 16 are distributed in a uniform manner (evenly) over the first sensor electrodes 11 and the dummy electrodes 14. The cuts are provided such that they are distributed in a uniform manner (evenly) over the first electrode layer 10 in a plan view.

With the cuts being provided on the conductive lines disposed in a uniform mesh-pattern, a region with high transmittance is created where the cuts are provided. Thus, when the provided cuts only include the first cuts 15 made along the outline of the first sensor electrodes 11, a region with high transmittance is created along the outline of the first sensor electrodes 11.

However, the touch panel substrate 2 according to the present embodiment includes the second cuts 16 in addition to the first cuts 15. Thus, as shown in FIG. 5, the transmittance in a plan view can be made more uniform and the regions with high transmittance that correspond to the first cuts 15 can be made less noticeable.

As described above, the second cuts 16 are provided such that the electrical continuity of the first sensor electrodes 11 is maintained. In other words, the second cuts 16 are provided such that the second cuts 16 do not insulate one end of the first sensor electrode 11 from another end thereof. Thus, the second cuts 16 do not take away the ability of the touch panel substrate 2 to detect the position of an object.

When the difference in transmittance between the first sensor electrodes 11 and the dummy electrodes 14 is large, there is a risk that the shapes of the first sensor electrodes 11 and the dummy electrodes 14 will become noticeable as a pattern. Thus, with respect to the transmittance of the first sensor electrodes 11 and the transmittance of the dummy electrodes 14, it is preferable that the lower transmittance thereof be at least 0.95 times the higher transmittance thereof.

In the touch panel substrate 2 according to the present embodiment, the transmittance in a plan view improves as a whole by providing the second cuts 16. Thus, in the electronic apparatus 1 equipped with the touch panel substrate 2 and the display device 3, the losses in the touch panel substrate 2 of light emitted from the display device 3 can be reduced. As a result, the ability to conserve energy can be improved.

In the description above, the detailed configuration of the first sensor electrodes 11 and the dummy electrodes 14 of the first electrode layer 10 is described. Because the configuration of the second sensor electrodes 21 and the dummy electrodes 24 of the second electrode layer 20 is similar, the description thereof is omitted.

### Comparison Example

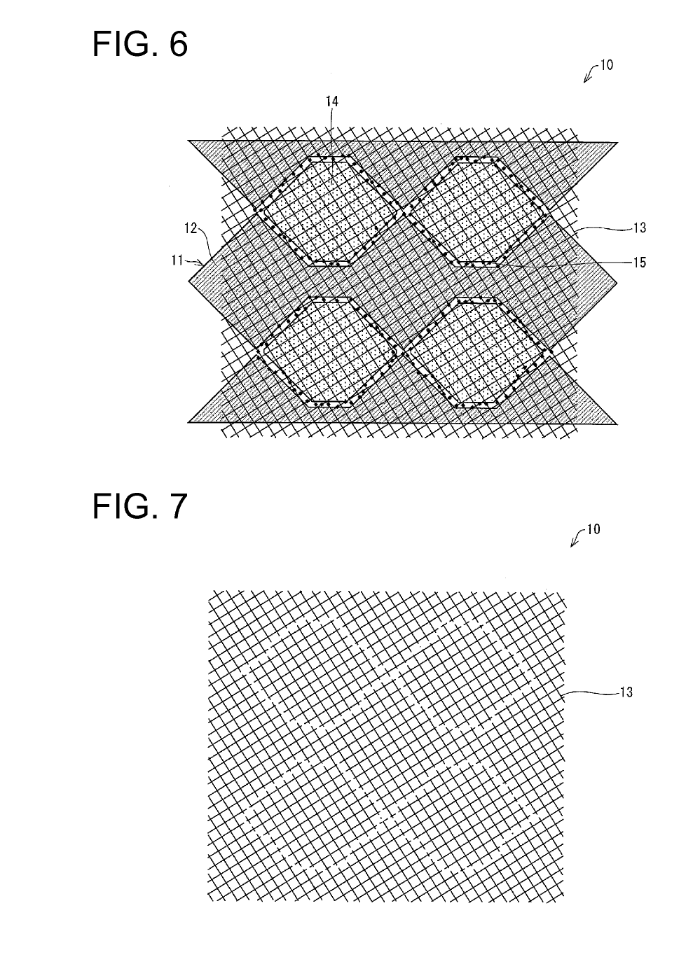

FIG. 6 is a plan view showing cuts in first conductive lines in a first electrode layer of a conventional touch panel substrate as a comparison example. FIG. 7 is a plan view showing a detailed configuration of first conductive lines of a conventional touch panel substrate as a comparison example.

As shown in FIG. 6, in a touch panel substrate of the comparison example, the first cuts 15 are provided only along the outline of the first sensor electrodes 11, not on the first sensor electrodes 11 and the dummy electrodes 14.

Thus, as FIG. 7 shows, the region of high transmittance formed along the outline of the first sensor electrodes 11 becomes noticeable. As a result, in an electronic apparatus that combines a touch panel substrate and a display device, a pattern that corresponds to the first cuts 15 becomes noticeable, which lowers the visibility of a displayed image.

<Transmittance>

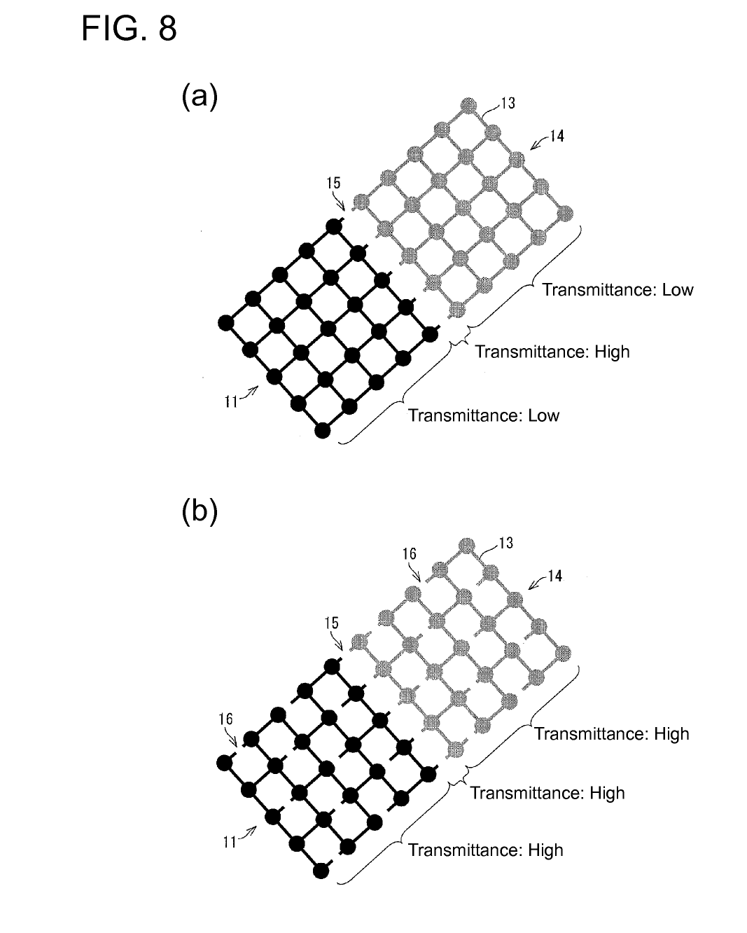

FIG. 8 is a plan view used to describe the transmittance of the first electrode layer, FIG. 8(a) is a plan view of a first electrode layer of a touch panel substrate in a comparison example, and FIG. 8(b) is a plan view of a first electrode layer of a touch panel substrate according to the present invention.

As shown in FIG. 8(a), because the cuts are not provided on the first sensor electrode 11 and the dummy electrode 14 in the touch panel substrate of the comparison example, the transmittance of the first sensor electrode 11 and the dummy electrode 14 is lower than the transmittance of the border between the first sensor electrode 11 and the dummy electrode 14.

In contrast, as shown in FIG. 8(b), because the second cuts 16 are provided on the first sensor electrode 11 and the dummy electrode 14 in the touch panel substrate 2 according to the present embodiment, not only is the transmittance of the border between the first sensor electrode 11 and the dummy electrode high, but also transmittance of the first sensor electrode 11 and the dummy electrode 14 is high. For this reason, the transmittance in a plan view can be made even.

By perceiving variation in brightness with the eye, human beings recognize the variation in brightness as a pattern. Typically, the resolution of the human eye is between 70 μm to 80 μm. However, even when the size of an object causing the variation in brightness is 70 μm or less, if the difference between the brightness within a field of view of a person and the average brightness around the object is greater than a certain magnitude, the person could see the object.

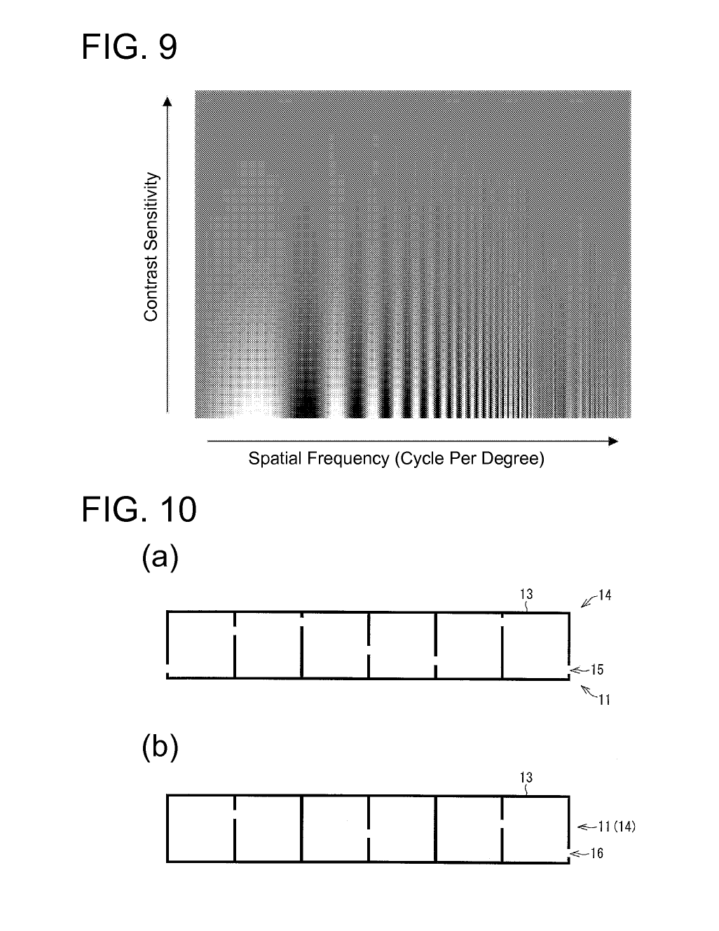

In the mesh-like configuration of conductive lines used for the sensor electrodes, the cuts (cut-outs) provided to prevent a short circuit among the sensor electrodes create variation in brightness between the mesh portion and the cuts, making this variation visible. As the Campbell-Robson chart in FIG. 9 shows, whether a pattern can be seen depends on spatial frequency and contrast sensitivity (difference in transmittance).

As shown in FIGS. 7 and 8(a), if the provided cuts include only the first cuts 15 used to partition the first sensor electrodes 11 and the dummy electrodes 14, a pattern that matches the arrangement of the first cuts 15 appears near the spatial frequency that corresponds to the pitch of the first conductive lines 13 having a mesh-like configuration. At that spatial frequency, if the contrast sensitivity of the pattern becomes lower than the threshold contrast sensitivity below which the human eye becomes capable of detecting the pattern, the first cuts 15 become visually recognizable.

In the touch panel substrate 2 according to the present embodiment, the second cuts 16 are provided on the first conductive lines 13 that constitute the first sensor electrodes 11 and the dummy electrodes 14. Thus, as shown in FIGS. 5 an 8(b), the transmittance of the first sensor electrodes 11 and the dummy electrodes 14 is improved.

This configuration reduces the difference between the transmittance of the interior of the first sensor electrodes 11 and the dummy electrodes 14 and the transmittance of the border between the first sensor electrodes 11 and the dummy electrodes 14. As a result, the difference in transmittance can be held below the recognition threshold for the human eye, and the pattern along the outline of the first sensor electrodes 11 can be made harder to see

(Conductive Lines and Cut Portions)

The first sensor electrodes 11 can be formed by etching the first conductive lines 13 on the first electrode substrate 6, for example. Specifically, the sensor electrodes having a mesh-like copper wiring pattern are made by forming thin film such as copper on the first electrode substrate 6 and etching using a mask having mesh-shaped light-shielding portions. The cuts can also be formed by etching.

It is preferable that the length of the cuts in the direction in which the conductive lines extend be 150 μm or smaller. Although there is a risk that the user of the electronic apparatus 1 will notice the cuts when the length thereof becomes longer than 150 μm, as long as the size thereof is 150 μm or smaller, the user would not notice the cuts, and the deterioration of the display quality of a displayed image can be curtailed.

In the touch panel substrate according to Embodiment 1 and the comparison example, the width of the first conductive lines 13 is 10 μm, the pitch (the distance between the wires) is 350 μm, and the length of the cuts is 80 μm. In the touch panel substrate according to the comparison example, the transmittance when the first and the second electrode layers are stacked is 89.1%. In contrast, in the touch panel substrate 2 according to Embodiment 1, the transmittance when the first electrode layer 10 and the second electrode layer 20 are stacked is 90.3%, which is an improvement compared to the transmittance of the touch panel substrate according to the comparison example.

Intersections of the conductive lines can be formed wider than the other parts of the conductive lines. In particular, when forming the conductive lines by etching, the process of etching the intersections can take longer, making the width of the conductive lines at the intersections wider.

If cuts are provided at the intersections, the difference in transmittance between the intersections with the cuts and the intersections without cuts becomes large. Considering this, it is preferable that cuts be provided at positions other than the intersections of the first conductive lines 13. By not providing cuts at the intersections, the variation in transmittance caused by cuts can be reduced, and the transmittance within the surface of the first electrode layer 10 can be made more even.

FIG. 10 is a plan view of a portion of a first electrode layer of a touch panel substrate according to Embodiment 1 used to describe the position where cuts are provided, FIG. 10(a) is a plan view of a border between a first sensor electrode and a dummy electrode, and FIG. 10(b) is a plan view showing a first sensor electrode or a dummy electrode.

The human eye is sensitive to periodic structure. When a large number of the first cuts 15 are placed in the same straight line along one of the sides that form the outline of the first sensor electrode 11 or along one of the sides that form the outline of the dummy electrode 14, the first cuts 15 become easier to see, and there is a risk that the pattern along the outline of the first sensor electrodes 11 will become recognizable. For this reason, as shown in FIG. 10(a), it is preferable that a large number of the first cuts 15 be not provided on the same straight line.

Specifically, as shown in FIGS. 2(a) and 4, it is preferable that the number of the first cuts 15 placed in the same straight line along a side 17, which is one of the sides that form the outline of the first sensor electrode 11, or a side 18, which is one of the sides that form the outline of the dummy electrode 14, be small. Also, it is preferable that the first cuts 15 be provided randomly so that the first cuts 15 are not arranged in a periodic manner. It is preferable that no more than three first cuts 15 be provided in the same straight line along the side 17 or the side 18, each of which is one of the sides that form the outline of the first sensor electrode 11 or the dummy electrode 14, respectively, for example. Similarly, it is preferable that no more than three first cuts 15 be provided in the same straight line along a side 27 or a side 28, each of which is one of the sides that form the outline of the second sensor electrode 21 or the dummy electrode 24, respectively.

A lattice square is the smallest unit formed by the first conductive lines 13. Suppose that the cut 15 is provided in each of the walls partitioning the respective lattice squares from one another. In this case, in each of the walls, the cut 15 is provided at one of the six points that subdivide one wall into seven equal parts, and each of these cuts will be provided randomly at one of these locations that are different from neighboring cuts. In other words, suppose that the six points that subdivide one of the walls of the smallest unit lattice into seven equal parts are respectively defined as first subdivision point, second subdivision point, third subdivision point, fourth subdivision point, fifth subdivision point, and sixth subdivision point from the side of the first sensor electrode 11. In this case, the location of the cut 15 in each of the walls of the smallest unit lattice is picked randomly from these six subdivision points.

As shown in FIG. 10(b), it is preferable that the second cuts 16 be provided in the first sensor electrodes 11 (or the dummy electrodes 14) randomly (irregularly) in a manner similar to the first cuts 15.

This configuration makes the first cuts 15 difficult to be seen and makes the pattern formed along the outline of the first sensor electrodes 11 and the second sensor electrodes 21 difficult for the user to recognize.

### Embodiment 2

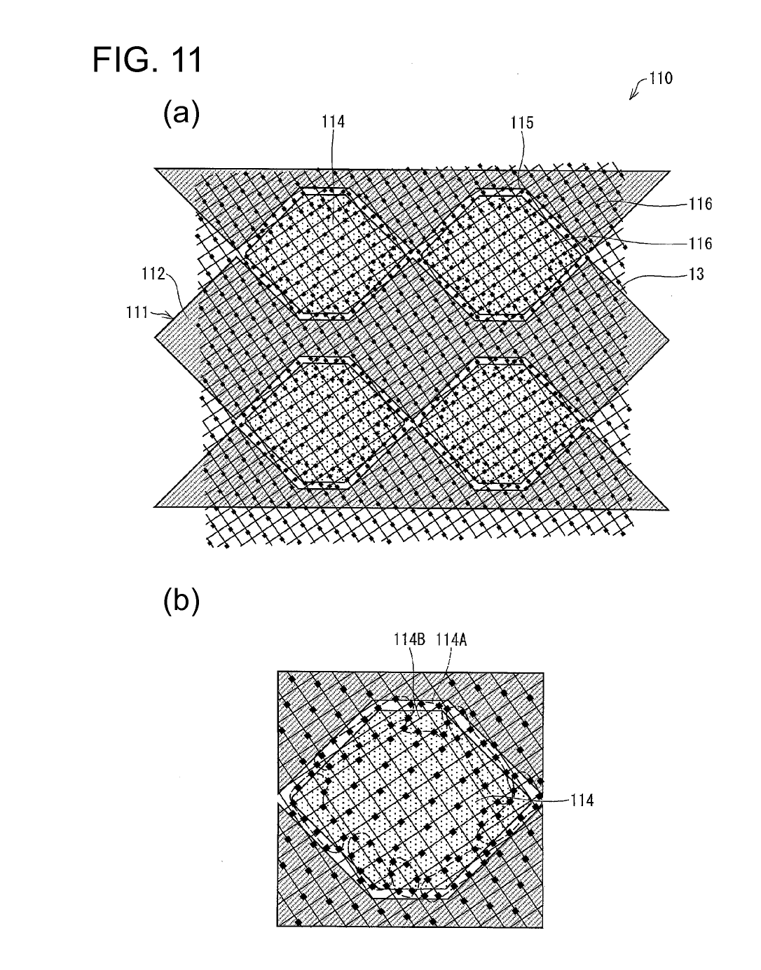

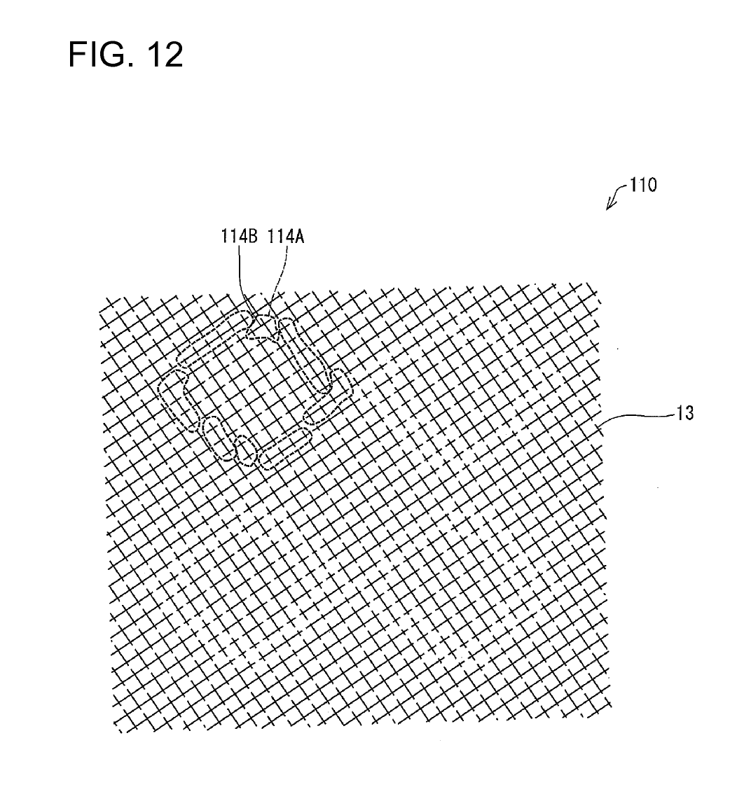

Another embodiment according to the present invention is described below with reference to FIGS. 11 to 12. For ease of explanation, the components having the same functions as those in the drawings described in the embodiment above are given the same reference characters, and the descriptions thereof are omitted.

<First Sensor Electrode and Dummy Electrode>

FIG. 11 is a plan view showing a first electrode layer of a touch panel substrate according to the present embodiment, FIG. 11(a) is a view showing cuts in first conductive lines of a first electrode layer, and FIG. 11(b) is an enlarged view of a dummy electrode shown in FIG. 11(a). FIG. 12 is a plan view showing a detailed configuration of first conductive lines of a touch panel substrate according to the present embodiment.

As shown in FIG. 11(a), second cuts 116 are provided in a first electrode layer 110 of a touch panel substrate according to the present embodiment. The second cuts 116 sever first conductive lines 13 that constitute first sensor electrodes 111 while maintaining the electrical continuity of the first sensor electrodes 111. The second cuts 116 that sever the first conductive lines 13, which constitute dummy electrodes, are also provided.

The second cuts 16 are provided as to be distributed in a uniform manner (evenly) over the first sensor electrodes 111 and the dummy electrodes 114. The cuts are provided as to be distributed in a uniform manner (evenly) over the first electrode layer 110 in a plan view.

As shown in FIG. 12, in a manner similar to the touch panel substrate 2 according to Embodiment 1, the transmittance in a plan view can be made more uniform, and the regions with high transmittance that correspond to the first cuts 15 can be made less noticeable.

Here, while the electrical continuity of the first sensor electrodes 111 needs to be maintained so that the touch panel substrate has the ability to detect the positions of objects, the electrical continuity of the dummy electrodes 114 does not need to be maintained. As FIG. 11(b) shows, in the touch panel substrate according to the present embodiment, the first conductive lines 13 that constitute the dummy electrodes 114 are partitioned by the second cuts 116 (the second cuts for the dummy electrodes). A plurality of sub-dummy electrodes 114B that are mutually insulated are formed by the partitioned first conductive lines 13 (see the dotted line frames 114A in the figure). In other words, the first conductive lines 13 that constitute the dummy electrodes 114 are broken into smaller parts and isolated, and the isolated first conductive lines 13 constitute the sub-dummy electrodes 114B.

In this configuration, even when a short circuit occurs between the first sensor electrodes 111 and the dummy electrodes 114, the first sensor electrodes 111 become electrically connected only to the sub-dummy electrodes 114B. In the event of short circuit, this configuration prevents the first sensor electrodes 111 from getting bigger and avoids the resulting significant change in capacitance, contributing to an increase in manufacturing yield.

The detailed configuration of the first sensor electrodes 111 and the dummy electrodes 114 of the first electrode layer 110 was described above. Because the configuration of the second sensor electrodes 121 and the dummy electrodes 124 of the second electrode layer 120 is similar, the description thereof is omitted.

### Embodiment 3

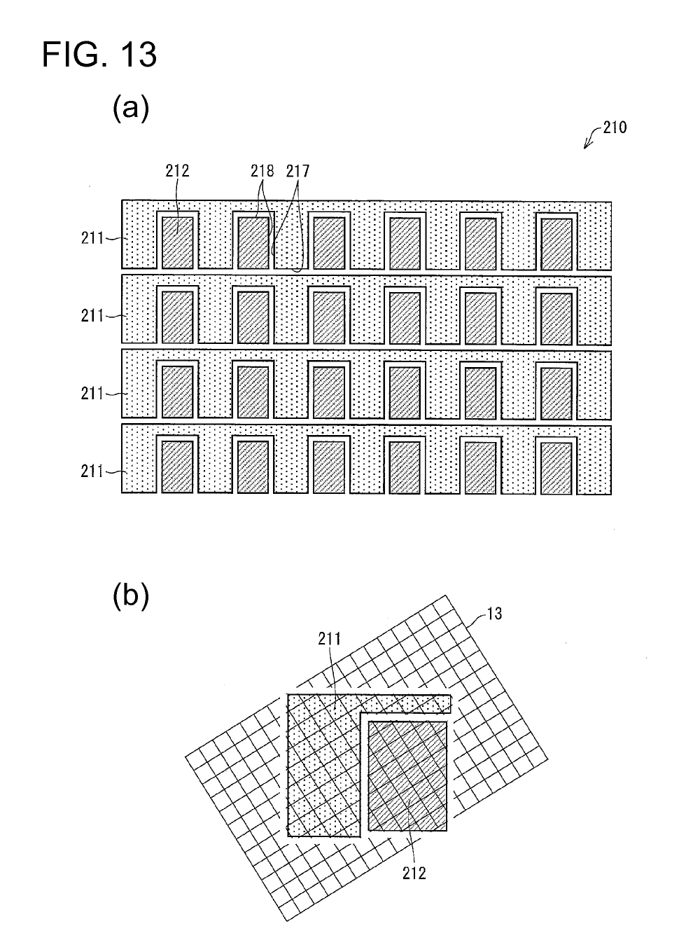

Another embodiment according to the present invention is as described below with reference to FIGS. 13 to 16. For ease of explanation, the components having the same functions as those in the drawings described in the embodiment above are given the same reference characters, and the descriptions thereof are omitted.

<Electrode Layer>

Below, the configuration of a first electrode layer 210 and a second electrode layer 220 of a touch panel substrate according to the present embodiment is described specifically.

FIG. 13 is a plan view showing a configuration of a first electrode layer of a touch panel substrate according to the present embodiment, FIG. 13(a) is a view showing a configuration of first sensor electrodes, and FIG. 13(b) is a view showing a configuration of first conductive lines.

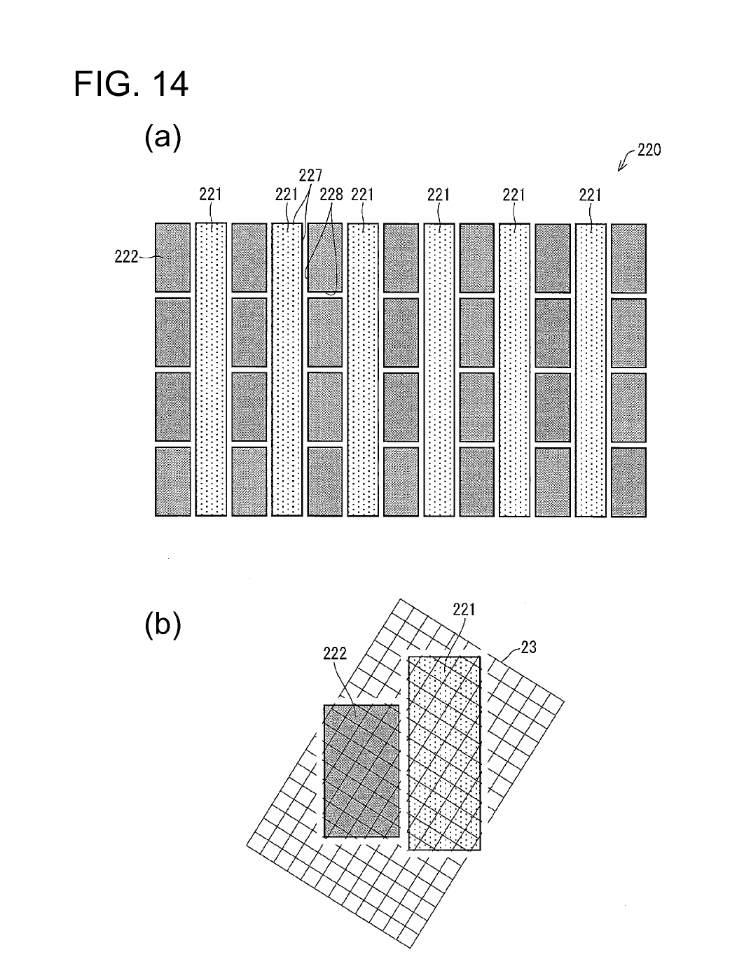

FIG. 14 is a plan view showing a configuration of a second electrode layer of a touch panel substrate according to the present embodiment, FIG. 14(a) is a view showing a configuration of second sensor electrodes, and FIG. 14(b) is a view showing a configuration of second conductive lines.

As shown in FIG. 13(a), the first electrode layer 210 includes a plurality of first sensor electrodes 211 that extend in the horizontal direction in the figure. The first sensor electrode 211 has a rectangular shape with recessed portions. The distance between the adjacent recessed portions in each of the first sensor electrodes 211 is the same as the distance between adjacent second sensor electrodes 221 that are described later. Dummy electrodes 212 are also provided in the recessed portions of the first sensor electrodes 211.

As shown in FIG. 13(b), the first sensor electrode 211 and the dummy electrode 212 are constituted by first conductive lines 13 disposed in a mesh-pattern. More specifically, the first conductive lines 13 are disposed in a mesh-pattern on the first electrode layer 210 in a uniform manner. Cutting the first conductive lines 13 along the outline of the first sensor electrode 211 forms the first sensor electrode 211 and the dummy electrode 212 on the first electrode layer 210.

As shown in FIG. 14(a), the second electrode layer 220 includes a plurality of the second sensor electrodes 221 that extend in the vertical direction in the figure. The second sensor electrode 221 has a thin rectangular shape. Dummy electrodes 222 are also provided between the second sensor electrodes 221.

As shown in FIG. 14(b), the second conductive lines 23 disposed in a mesh-pattern constitute the second sensor electrode 221 and the dummy electrode 222. More specifically, the second conductive lines 23 are disposed in a mesh-pattern on the second electrode layer 220 in a uniform manner. Cutting the second conductive lines 23 along the outline of the second sensor electrode 221 forms the second sensor electrode 221 and the dummy electrode 222 on the second electrode layer 220.

The first electrode layer 210 and the second electrode layer 220 are attached such that the second sensor electrodes 221 and the recessed portions of the first sensor electrodes 211 overlap, respectively.

As described above, the touch panel substrate according to the present embodiment includes a simple matrix constituted by the first sensor electrodes 211 and the second sensor electrodes 221.

Below, the detailed configuration of the first sensor electrodes 211 of the touch panel substrate according to the present embodiment is described.

<First Sensor Electrode and Dummy Electrode>

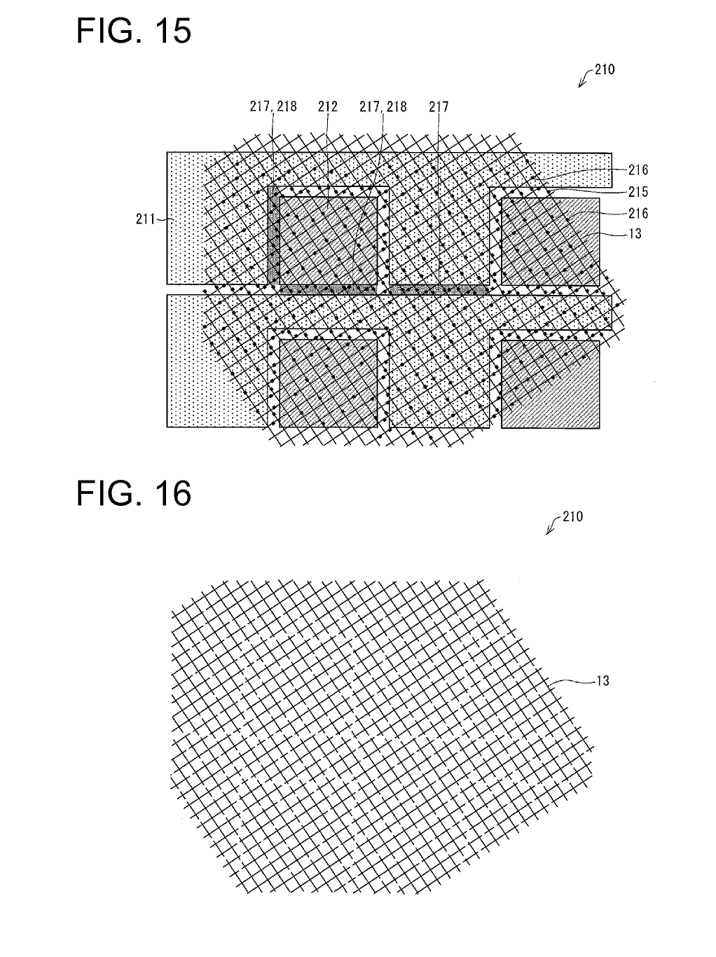

FIG. 15 is a plan view showing cuts in first conductive lines in a first electrode layer of a touch panel substrate according to the present embodiment. FIG. 16 is a plan view showing a detailed configuration of first conductive lines of a touch panel substrate according to the present embodiment.

For ease of description, in FIG. 15, the shapes of the first conductive lines 13, the first sensor electrodes 211, and the dummy electrodes 212 are shown, and the positions where the first conductive lines 13 are cut are shown with square dots. FIG. 16 shows only the first conductive lines 13, which include the cuts.

In a manner similar to the touch panel substrate 2 according to Embodiment 1, second cuts 216, which sever the first conductive lines 13 that constitute the first sensor electrodes 211, are provided while maintaining the electrical continuity of the first sensor electrodes 211. The second cuts 216 also sever the first conductive lines 13 that constitute the dummy electrodes 212.

The second cuts 216 are distributed in a uniform manner (evenly) over the first sensor electrodes 211 and the dummy electrodes 212.

In this configuration, as shown in FIG. 16, the transmittance in a plan view can be made more uniform, and the regions with high transmittance that correspond to the first cuts 215 can be made less noticeable in a manner similar to the touch panel substrate 2 according to Embodiment 1.

As shown in FIGS. 13(a) and 15, in a manner similar to the touch panel substrate according to Embodiment 1, it is also preferable that no more than three first cuts 215 be placed in the same straight line along a side 217 or a side 218, each of which is one of the sides that form the outline of the first sensor electrode 211 or the dummy electrode 212, respectively. Similarly, it is preferable that no more than three first cuts 215 be placed in the same straight line along the side 227 or 228, each of which is one of the sides that forms the outline of the second sensor electrode 221 or the dummy electrode 222 respectively.

Furthermore, it is preferable that the second cuts 216 be provided randomly (irregularly) in the first sensor electrodes 211 (or the dummy electrodes 212).

This configuration makes the first cuts 215 more difficult to be seen and the pattern formed along the outline of the first sensor electrodes 211 and the second sensor electrodes 221 difficult for the user of an electronic apparatus 1 to recognize.

The detailed configuration of the first sensor electrodes 211 and the dummy electrodes 212 of the first electrode layer 210 was described above. Because the configuration of the second sensor electrodes 221 and the dummy electrodes 222 of the second electrode layer 220 is similar, the description thereof is omitted.

### Embodiment 4

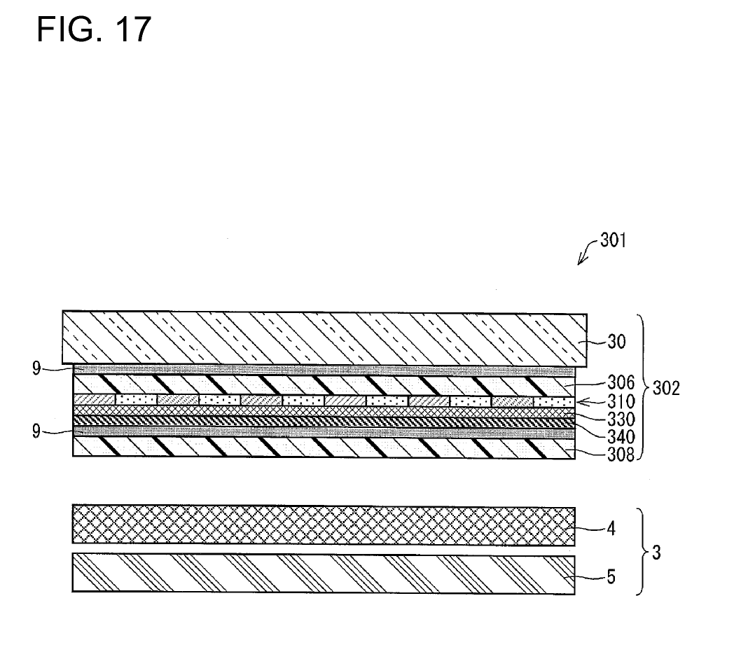

Another embodiment directed to a display device of the present invention will be explained below with reference to FIGS. 17 to 19. For ease of explanation, the components having the same functions as those in the drawings described in the embodiment above are given the same reference characters, and the descriptions thereof are omitted.

FIG. 17 is a cross-sectional view of an electronic apparatus 301 according to the present embodiment. As shown in FIG. 17, the electronic apparatus 301 includes a touch panel substrate 302 and a display device 3.

The touch panel substrate 302 is configured by layering a glass substrate 30, an electrode substrate 306, an electrode layer 310, a contact-hole-forming layer 330, a bridge-forming layer 340, and a substrate 308 in this order. Each of the following two sets of layers—the glass substrate 30 and the electrode substrate 306, and the bridge-forming layer 340 and the substrate 308—is bonded together with an adhesive layer 9 therebetween.

<Electrode Layer>

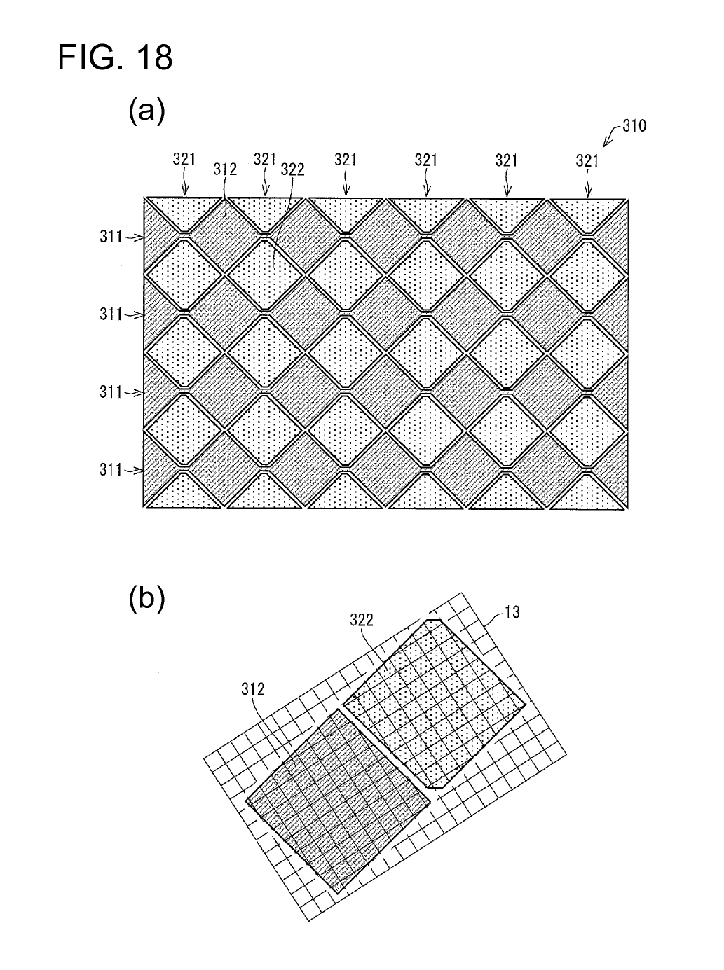

FIG. 18 is a plan view showing a configuration of an electrode layer of a touch panel substrate according to the present embodiment, FIG. 18(a) is a view showing a configuration of first sensor electrodes and second sensor electrodes, and FIG. 18(b) is a view showing a configuration of first conductive lines and second conductive lines.

As shown in FIG. 18(a), the first electrode layer 310 includes a plurality of first sensor electrodes 311 that extend in the horizontal direction in the figure and a plurality of second electrodes 321 that extend in the vertical direction in the figure. Each of the first sensor electrodes 311 has a plurality of grid electrodes 312 shaped like a square, and the adjacent grid electrodes 312 are connected to each other at one of the vertices thereof. Each of the second sensor electrodes 321 has a plurality of grid electrodes 322 shaped like a square, and the adjacent grid electrodes 322 are connected to each other at one of the vertices thereof.

As shown in FIG. 18(b), the first conductive lines 13 in a mesh-pattern constitute the first sensor electrode 311 and the second sensor electrode 321. More specifically, the first conductive lines 13 are disposed in a mesh-pattern on the electrode layer 310 in a uniform manner. Cutting the first conductive lines 13 along the outlines of the first sensor electrode 311 and the second sensor electrode 321 forms the first sensor electrode 311 and the second sensor electrode 321 on the electrode layer 310.

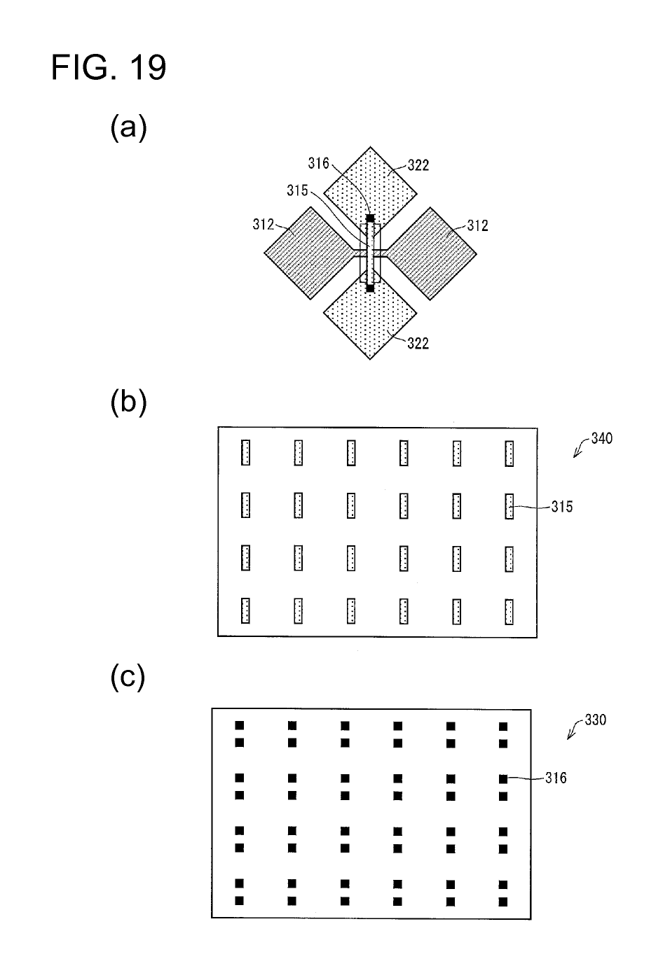

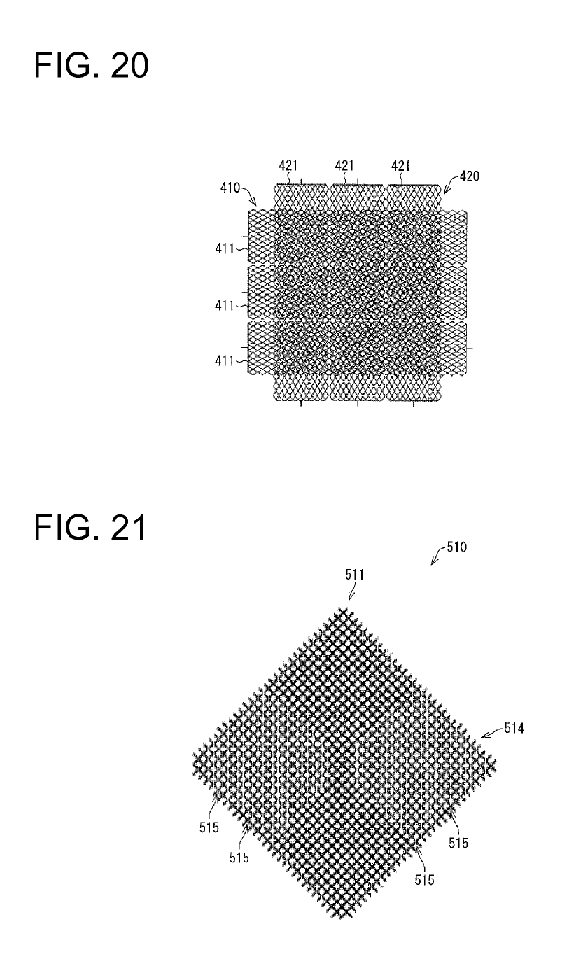

FIG. 19 is a plan view showing a configuration of a bridge portion of a touch panel substrate according to the present embodiment, FIG. 19(a) is a view showing a bridge that connects grid electrodes, FIG. 19(b) is a plan view showing a bridge-forming layer, and FIG. 19(c) is a plan view showing a contact-hole-forming layer.

As shown in FIG. 19(a), the electrode layer 310 has a bridge portion 315 used to mutually connect the grid electrodes 322 included in the single second sensor electrode 321. The bridge portion 315 is insulated from the first sensor electrodes 311 and connected to the grid electrodes 322 of the second sensor electrodes 321 via the contact holes 316.

As shown in FIG. 19(b), a plurality of the bridge portions 315 are formed on the bridge-forming layer 340 in accordance with the positions of the grid electrodes 322. As shown in FIG. 19(c), a plurality of the contact holes 316 are formed on the contact-hole-forming layer 330 in accordance with the positions of the grid electrodes 322 and the bridge portions 315.

According to this configuration, the first sensor electrodes 311 and the second sensor electrodes 321 are formed on the single electrode layer 310 in the touch panel substrate 302 according to the present embodiment.

In a manner similar to Embodiment 1, providing the second cuts in the first sensor electrodes 311 and the second sensor electrodes of the touch panel substrate 302 according to the present embodiment moderates the difference between the transmittance of the border between the first sensor electrodes 311 and the second sensor electrodes 321 and the transmittance of the interior of the first sensor electrodes 311 and the second sensor electrodes 321. As a result, it is possible to reduce the lowering of the display visibility, a problem that occurs when the outlines of the first sensor electrodes 311 and the second sensor electrodes 321 become visible as patterns.

### SUMMARY

The touch panel substrate 2 according to aspect 1 of the present invention is a touch panel substrate 2 including: electrode layers (first electrode layer 10, second electrode layer 20) having a plurality of electrodes (first sensor electrodes 11 and second sensor electrodes 21) made from conductive lines (first conductive lines 13, second conductive lines 23), wherein the conductive lines are provided in a mesh-pattern in the electrode layer, wherein first cuts 15 for severing the conductive lines are provided in the electrode layer and the plurality of electrodes each insulated from one another are formed by partitioning the conductive lines disposed in a mesh-pattern with the first cuts, and wherein second cuts 16 for severing the conductive lines that are included in the electrodes are further provided on the electrodes while maintaining an electrical continuity within each of the electrodes.

According to the configuration described above, due to the second cuts in addition to the first cuts, the transmittance in a plan view can be improved and the region of high transmittance formed by the first cuts be made less noticeable. As a result, the deterioration of display quality in an electronic apparatus that combines a touch panel substrate and a display device can be curtailed. It should be mentioned that the touch panel substrate does not lose the ability to detect the positions of objects because the second cuts are disposed such that the electrical continuity of the electrodes is maintained.

A touch panel substrate according to aspect 1 of the present invention is aspect 1, in which the first cuts and the second cuts may not be provided at points where the conductive lines intersect.

When the conductive lines in a mesh-pattern are formed by etching, the width of the conductive lines at where the conductive lines intersect becomes wider than the width of the rest of the conductive lines and the transmittance at the intersections can become low. For this reason, when the cuts are provided at the intersections, the difference in transmittance between the places with and without the cuts becomes large, which makes the cuts able to be seen. In view of this problem, the configuration described above can be used to reduce the variation in transmittance due to the provision of the cuts and to make the cuts harder to be seen.

The touch panel substrate according to aspect 3 of the present invention is aspect 1 or 2, in which a size of the first cuts and the second cuts in a direction in which the conductive lines extend may be 150 μm or less.

The configuration described above can be used to make the cuts harder to be seen.

The touch panel substrate according to aspect 4 of the present invention is any of aspects 1 to 3, in which no more than three first cuts may be provided along at least one of sides that form an outline of each of the electrodes in a same straight line.

Because the human eye is sensitive to periodic structure, when a large number of first cuts are provided on the same straight line along one of the sides that forms the outline of each of the electrodes, the pattern along the outline of the electrodes can be recognized.

In view of this problem, the configuration described above can be used to make the first cuts harder to be seen.

The touch panel substrate according to aspect 5 of the present invention is any one of aspects 1 to 4, in which positions where the second cuts are provided in the electrodes may be irregular.

The configuration described above can be used to make the second cuts harder to be seen.

The touch panel substrate according to aspect 6 of the present invention is any one of aspects 1 to 5, in which sensor electrodes and dummy electrodes adjacent to the electrodes are disposed on the electrode layer, in which the second cuts for the dummy electrodes for severing the conductive lines that are included in the dummy electrodes are provided on the dummy electrodes.

The touch panel substrate according to aspect 7 of the present invention is aspect 6, in which the second cuts for the dummy electrodes are provided as to partition the dummy electrodes into a plurality of sub-dummy electrodes that are insulated from one another.

In this configuration described above, even when a short circuit occurs between the sensor electrodes and the dummy electrodes, the sensor electrodes become electrically connected only to the sub-dummy electrodes. As a result, in the event of short circuit, this configuration prevents the sensor electrodes from getting bigger and avoids the resulting significant change in capacitance, increasing manufacturing yield.

The touch panel substrate according to aspect 8 of the present invention is aspect 6 or 7, in which, between a transmittance of the sensor electrodes and a transmittance of the dummy electrodes, a lower transmittance thereof is 0.95 times or higher than a higher transmittance thereof.

In the configuration described above, because the difference in transmittance between the sensor electrodes and the dummy electrodes is sufficiently small, the patterns that correspond to the sensor electrodes and the dummy electrodes become harder to be seen.

An electronic apparatus 1 according to aspect 9 of the present invention includes: a touch panel substrate according to any one of aspects 1 to 8; and a display device 3.

According to the configuration described above, the overall transmittance improves compared to a touch panel substrate without the second cuts. For this reason, the electronic apparatus according to aspect 9 of the present invention can conserve energy more efficiently compared to an electronic apparatus equipped with a touch panel substrate without the second cuts because the losses of light emitted from the display device in the touch panel substrate can be reduced.

The present invention is not limited to the respective embodiments described above, and various modifications can be applied within the scope of the claims. Therefore, embodiments that appropriately combine the techniques described in different embodiments are included in the technical scope of the present invention. Moreover, new technical features can be created by combing the technical configurations described in the respective embodiments.

### INDUSTRIAL APPLICABILITY

The present invention can be suitably used for a touch panel substrate equipped with electrodes made of conductive lines.

### DESCRIPTION OF REFERENCE CHARACTERS

1, 310 electronic apparatus
2, 302 touch panel substrate
3 display device
10, 110, 210 first electrode layer (electrode layer)
20, 120, 220 second electrode layer (electrode layer)
310 electrode layer
11, 111, 211, 311 first sensor electrode (sensor electrode)
21, 121, 221, 321 second sensor electrode (sensor electrode)
14, 24, 114, 124, 212, 222 dummy electrode
114A sub-dummy electrode
13 first conductive line (conductive line)
23 second conductive line (conductive line)
15, 215 first cut
16, 116, 216 second cut

1. A touch panel substrate, comprising:
a substrate; and
an electrode layer, including a plurality of electrodes that are electrically insulated from one another, on the substrate, the electrode layer being made from a two-dimensionally uniform mesh of conductive lines on the substrate such that each of the plurality of electrodes corresponds to a pattern in the uniform mesh of conductive lines having a shape as if the pattern is cut out from the uniform mesh along a plurality of first cuts respectively provided on some of the conductive lines that constitute the uniform mesh, said first cuts on the conductive lines thereby defining boundaries of the electrodes,
wherein said plurality of electrodes each further include second cuts on at least some of the conductive lines therein that maintain an electrical continuity within the electrode.

2. The touch panel substrate according to claim 1, wherein said first cuts and said second cuts are not provided at points where said conductive lines intersect.

3. The touch panel substrate according to claim 1, wherein each of the first and second cuts has a length of 150 μm or less in an extending direction of the corresponding conductive line having the first or second cut.

4. The touch panel substrate according to claim 1, wherein, in each of said plurality of electrodes, along at least one of sides that form an outline thereof, no more than three said first cuts are placed in a same straight line.

5. The touch panel substrate according to claim 1, wherein positions where said second cuts are provided within said each of the electrodes are irregular.

6. The touch panel substrate according to claim 1,
wherein said plurality of electrodes in said electrode layer are a plurality of sensor electrodes, and said electrode layer further includes a plurality of dummy electrodes that are respectively adjacent to said plurality of sensor electrodes, each of the plurality of dummy electrodes corresponds to a pattern in the uniform mesh of conductive lines having a shape as if the pattern is cut out from the uniform mesh,
wherein said plurality of dummy electrodes each include third cuts therein on at least some of the conductive lines therein.

7. The touch panel substrate according to claim 6, wherein in each of the plurality of dummy electrodes, said third cuts define a plurality of sub-dummy electrodes each electrically insulated from one another within the dummy electrode.

8. The touch panel substrate according to claim 6, wherein a light transmittance of each sensor electrode is different from a light transmittance of each dummy electrode, and the lower of said light transmittances is at least 0.95 times the higher of said light transmittances.

9. An electronic apparatus, comprising:
the touch panel substrate according to claim 1; and
a display device.
